(19) United States
(12) Patent Application Publication
(10) Pub. No.: US 2026/0093916 A1
(43) Pub. Date: Apr. 2, 2026

(54) EXPANDING ABBREVIATED COLUMN NAMES IN TABULAR DATA USING ARTIFICIAL INTELLIGENCE MODELS

(71) Applicant: INTERNATIONAL BUSINESS MACHINES CORPORATION, Armonk, NY (US)

(72) Inventors: Michael Joseph Loughran, Naas (IE); Niall Jordan, Dunleer (IE); MARY O'NEILL, Kilcullen (IE)

(21) Appl. No.: 18/899,163

(22) Filed: Sep. 27, 2024

(51) Int. Cl. G06F 40/274; G06F 16/332

(52) U.S. Cl. CPC G06F 40/274; G06F 16/3329

(57) ABSTRACT

A method, system, and computer program product are configured to: extract, from metadata of a table in a database, a table name abbreviation of the table and plural column name abbreviations of plural columns in the table; automatically generate a prompt for an artificial intelligence (AI) model, the prompt including the table name abbreviation, the plural column name abbreviations, and an instruction to expand the table name abbreviation and the plural column name abbreviations; provide the prompt to the AI model using a single call to the AI model; receive an output generated by the AI model based on the prompt; and process the output.

### BACKGROUND

Aspects of the present invention relate generally to data engineering and, more specifically, to computer-based systems and methods for automatically expanding abbreviations of table and column names in tabular data.

Column names in a tabular data are often provided as abbreviations instead of full words. Abbreviations are often used in this context due to character length limits in many database systems. Column name expansion is the practice of expanding such abbreviations into full words.

### SUMMARY

In a first aspect of the invention, there is a computer-implemented method including: receiving, by a processor set and via a user interface, a user input identifying a table in a database; extracting, by the processor set and from metadata of the database, a table name abbreviation of the table and plural column name abbreviations of plural columns in the table; automatically generating, by the processor set, a prompt for an artificial intelligence (AI) model, the prompt including the table name abbreviation, the plural column name abbreviations, and an instruction to expand the table name abbreviation and the plural column name abbreviations; providing, by the processor set, the prompt to the AI model; receiving, by the processor set, an output generated by the AI model based on the prompt; and processing, by the processor set, the output.

In another aspect of the invention, there is a computer program product including one or more computer readable storage media having program instructions collectively stored on the one or more computer readable storage media. The program instructions are executable to: extract, from metadata of a table in a database, a table name abbreviation of the table and plural column name abbreviations of plural columns in the table; automatically generate a prompt for an artificial intelligence (AI) model, the prompt including the table name abbreviation, the plural column name abbreviations, and an instruction to expand the table name abbreviation and the plural column name abbreviations; provide the prompt to the AI model using a single call to the AI model; receive an output generated by the AI model based on the prompt; and process the output.

In another aspect of the invention, there is a system including a processor set, one or more computer readable storage media, and program instructions collectively stored on the one or more computer readable storage media. The program instructions are executable to: extract, from metadata of a table in a database, a table name abbreviation of the table and plural column name abbreviations of plural columns in the table; automatically generate a prompt for an artificial intelligence (AI) model, the prompt including the table name abbreviation, the plural column name abbreviations, and an instruction to expand the table name abbreviation and the plural column name abbreviations; provide the prompt to the AI model using a call to the AI model, wherein the call comprises a single application programming interface (API) call to the AI model or a single web service call to the AI model; receive an output generated by the AI model based on the prompt; and process the output.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment in accordance with aspects of the present invention.

FIG. 3 shows a block diagram of an exemplary workflow in accordance with aspects of the present invention.

FIG. 4 shows an exemplary predefined prompt format and an exemplary generated prompt in accordance with aspects of the present invention.

FIG. 5 shows an exemplary predefined prompt format and an exemplary generated prompt in accordance with aspects of the present invention.

FIG. 6 shows a flowchart of an exemplary method in accordance with aspects of the present invention.

### DETAILED DESCRIPTION

Aspects of the present invention relate generally to data engineering and, more specifically, to computer-based systems and methods for automatically expanding abbreviations of table and column names in tabular data. Implementations of the invention are configured to automatically generate a prompt for an artificial intelligence (AI) model, wherein the prompt includes a table name abbreviation of a table and column name abbreviations of the table and an instruction to the AI model to expand the table name abbreviation and the column name abbreviations. In embodiments, the table name abbreviation and all the column name abbreviations in the table are included in the prompt in a JavaScript Object Notation (JSON) format and sent to the AI model in a single call. Including all the column name abbreviations in a single call, along with the table name abbreviation, provides the AI model with context surrounding the column name abbreviations and improves the accuracy of the abbreviation expansion task performed by the AI model.

Column names in a tabular data, such as a table in a database, are often provided as abbreviations instead of full words. Such abbreviations can negatively impact the usefulness of the data in the table since the abbreviations might be misinterpreted by a search query or by a data engineer reviewing the data. As such, it is useful to expand the abbreviations to full words in a practice sometimes referred to as column name expansion.

One technique for expanding an abbreviation of a table or column name is to submit the abbreviation to a trained AI model such as a large language model (LLM) or a generative AI model. An LLM is a category of foundation model trained on immense amounts of data making it capable of understanding and generating natural language and other types of content to perform a wide range of tasks. Generative AI, sometimes called gen AI, is artificial intelligence that can create original content, such as text, images, video, audio or software code, in response to a user's prompt or request. However, trained AI models have a relatively low success rate of accurately expanding database table column name abbreviations when the column name abbreviations are provided to the AI trained model one at a time. For some AI models, submitting column name abbreviations one at a time to the AI trained model results in an accurate expansion only about 50% of the time. Accordingly, there is a need to improve the accuracy of expanding column name abbreviations when using AI models.

Implementations of the invention address this need by providing systems and methods that generate a prompt for an AI model and send the prompt to the AI model in a way that improves the accuracy of the AI model when expanding column name abbreviations of a database table. In embodiments, a prompt is automatically generated to include a table name abbreviation of the table and column name abbreviations of all the columns in the table, and this prompt is sent to the AI model in single call. Sending the table name abbreviation and all the column name abbreviations in a single call has the following advantages: (1) the plural column name abbreviations provide context to one another, and the AI model senses this context and provides more meaningful and accurate name expansions; and (2) AI model calls, such as LLM calls, are expensive in terms of time (i.e., latency) and cost (i.e., charge per tokens), and sending a single call including all the column name abbreviations instead of plural calls each with one column name abbreviation reduces the time and cost involved in obtaining expansions for all the column name abbreviations. In various embodiments, the prompt is automatically generated to include a table name abbreviation of the table and column name abbreviations in a JSON format. This has the advantage of being compatible with a table name abbreviation of the table and column name abbreviations that are contained in table metadata in the JSON format. This approach was tested with three different LLMs by generating a prompt for each of the LLMs, wherein each respective prompt included a table name abbreviation and all column name abbreviations for that table, in JSON format, and an instruction to expand the table name abbreviation and the plural column name abbreviations. This approach of passing the table name abbreviation and all the column name abbreviations for a table to the AI model in a single prompt, and in JSON format in that single prompt, resulted in improving the accuracy of all three LLMs by at least 10% compared to when the column name abbreviations were submitted individually in plural different prompts to each of the LLMs. The accuracy uplift of this approach will have meaningful impact on the Data Engineer/Steward/Science profession when dealing with obscure named columns, and thus provides an improvement in the technology of computer-based systems and methods for automatically expanding abbreviations of column names in tabular data.

Various aspects of the invention are related to generating a prompt for an LLM. In embodiments, the prompt provides a set of abbreviations taken from column headings in a table and instructs the LLM to expand the abbreviations of the table name and the set of column names. Surprisingly, the inventors have found that providing all of the column heading abbreviations from a single table in a single prompt provides significantly better results that providing only a single abbreviation at a time. According to aspects of the invention, there is a method comprising: identifying a plurality of related tasks to be performed by a trained artificial intelligence (AI) model, each task to be performed based on a corresponding item of input data; generating a prompt for the trained AI model, the prompt comprising an instruction to the AI model to perform the plurality of related tasks and the corresponding item of input data for each of the plurality of related tasks; and providing the prompt to the trained AI model. In embodiments, the trained AI model comprises a generative AI model. In embodiments, the generative AI model comprises a large language model (LLM). In embodiments, the plurality of related tasks comprises a table name and a plurality of column headings from a table, each of the plurality of column headings and the table name comprising an abbreviation representing an expression. In embodiments, the prompt comprises: the plurality of column headings; and an instruction to predict the expression represented by each abbreviation.

Implementations of the invention are necessarily rooted in computer technology. For example, the step of receiving, by a processor set and via a user interface, a user input identifying a table in a database is computer-based and cannot reasonably be performed in the human mind. As another example, the step of extracting, by a processor set and from metadata of the database, a table name abbreviation of the table and plural column name abbreviations of plural columns in the table is computer-based and cannot reasonably be performed in the human mind. In yet another example, the step of automatically generating, by a processor set, a prompt for an artificial intelligence (AI) model, the prompt including the table name abbreviation, the plural column name abbreviations, and an instruction to expand the table name abbreviation and the plural column name abbreviations; is computer-based and cannot reasonably be performed in the human mind. Moreover, embodiments of the claimed invention include steps of interacting directly with AI models, such as large language models and generative AI models, and thus are inherently computer based.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as abbreviation expansion code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

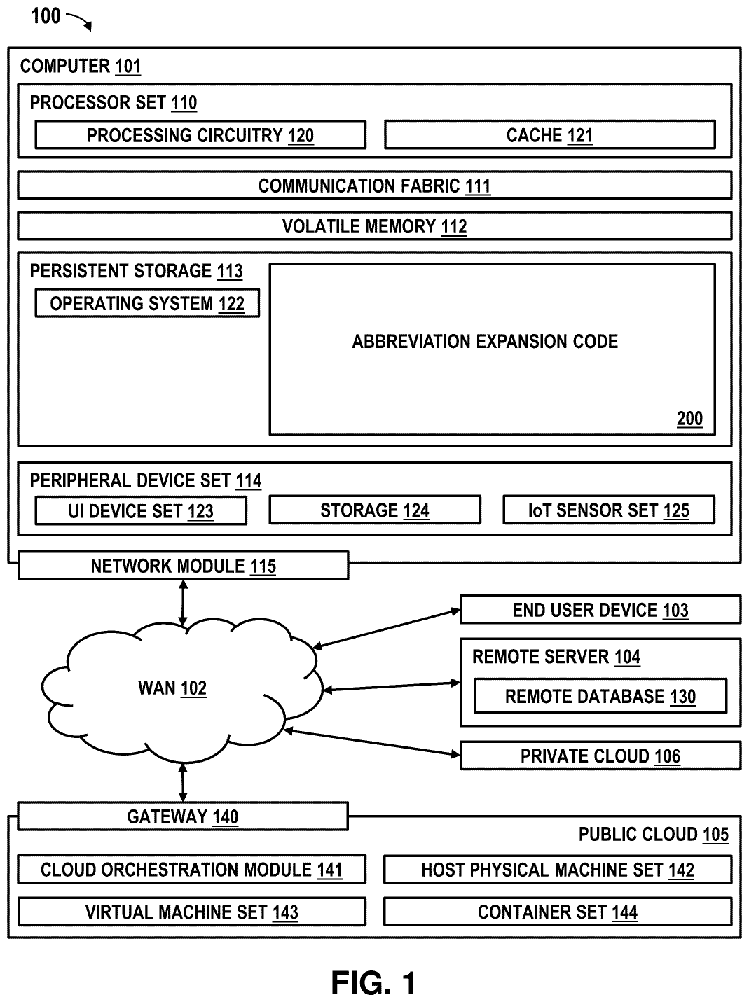

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not Separately Shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

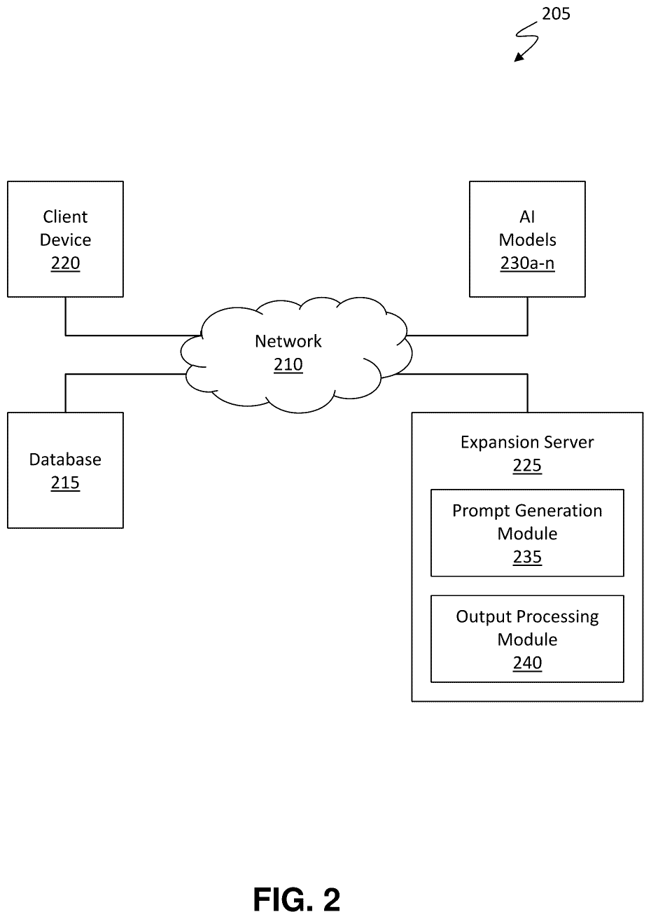

FIG. 2 shows a block diagram of an exemplary environment 205 in accordance with aspects of the invention. In embodiments, the environment 205 includes a network 210 that provides communication between various components such as a database 215, a client device 220, an expansion server 225, and one or more AI models 230a-n. The network 210 may include one or more networks such as the WAN 102 of FIG. 1. The database 215 may include one or more instances of the remote database 130 of FIG. 1. The client device 220 may include one or more instances of the EUD 103 of FIG. 1. In one example, the expansion server 225 includes one or more instances of the computer 101 of FIG. 1. In another example, the expansion server 225 includes one or more containers, or one or more virtual machines, running on one or more instances of the computer 101 of FIG. 1. The AI models 230a-n may comprise any integer number “n” of trained AI models, such a large language models or generative AI models, that are provided as software as a service (SaaS) via one or more microservices, web services, or monolithic applications.

In embodiments, the expansion server 225 of FIG. 2 comprises a prompt generation module 235 and an output processing module 240, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The expansion server 225 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In accordance with aspects of the invention, the prompt generation module 235 is configured to generate a prompt to one of the AI models 230a-n using a table name abbreviation and plural column name abbreviations that are associated with a table stored in the database 215. In embodiments, the prompt generation module 235 obtains the abbreviations from the database 215 by reading the database schema metadata of the database 215, which defines, among other things, names for the table and columns in terms of a table name abbreviation and column name abbreviations. In one example, the prompt generation module 235 uses an application programming interface (API) call (e.g., a representational state transfer (REST) API call) to obtain the abbreviations from the database 215.

In embodiments, the prompt generation module 235 generates a prompt for one of the AI models 230a-n by adding the obtained table name abbreviation and column name abbreviations to a prompt format associated with the one of the AI models 230a-n. The prompt generation module 235 may store or have access to different predefined prompt formats for different ones of the AI models 230a-n. For example, the prompt generation module 235 may store or have access to a first predefined prompt format for a first one of the AI models 230a-n (e.g., a granite model), a second predefined prompt format for a second one of the AI models 230a-n (e.g., a llama model), and a third predefined prompt format for a third one of the AI models 230a-n (e.g., a mixtral model), where each of the first, second, and third prompt formats are different from one another in that they are specifically tailored for their respective one of the AI models 230a-n. In embodiments, the prompt generation module 235 generates the prompt by adding the obtained table name abbreviation and all the obtained column name abbreviations in a JSON format to a selected one of the prompt formats.

In various embodiments, the prompt generation module 235 receives user input via a user interface of the client device 220, where the user input defines the table in the database 215 for which to expand the table name abbreviation and column name abbreviations. In this manner, a user may provide input to identify a particular table for which the prompt generation module 235 generates the prompt. In some embodiments, the prompt generation module 235 receives user input via a user interface of the client device 220, where the user input selecting one of the AI models 230a-n to use for expanding the abbreviations in the identified table. In these embodiments, the prompt generation module 235 generates the prompt using the one of the plural predefined prompt formats that corresponds to (i.e., is tailored to) the one of the AI models 230a-n selected in the user input.

In some embodiments, the prompt includes one or more examples each comprising an abbreviation and an expansion of the abbreviation. In some embodiments, the examples comprise a table name abbreviation and plural column name abbreviations and expansions of those table name and column name abbreviations. In one embodiment, each of the predefined prompt formats include one or more such examples. In this embodiment, the examples are predefined in the prompt format and do not necessarily match the table name abbreviation and the column name abbreviations being expanded, although it is possible that there might be some same terms between the examples and the abbreviations being expanded. In another embodiment, the user input includes one or more such examples and the prompt generation module 235 adds these examples received from the user to one of the predefined prompt formats when generating the prompt.

In accordance with aspects of the invention, the prompt generation module 235 provides the generated prompt to the one of the AI models 230a-n, e.g., by submitting the generated prompt as an input to the one of the AI models 230a-n via an API call or web service call. In embodiments, because the prompt generated in the manner described herein includes the table name abbreviation and all the column name abbreviations for the table, the act of providing the prompt to the one of the AI models 230a-n constitutes sending the table name abbreviation and all the column name abbreviations for the table to the one of the AI models 230a-n in a single call.

In accordance with aspects of the invention, the output processing module 240 is configured to receive an output generated by the one of the AI models 230a-n to which the prompt was provided and process the output. In embodiments, the one of the AI models 230a-n to which the prompt was provided generates an output based on the prompt, the output including an expanded table name corresponding to the table name abbreviation included in the prompt and plural expanded column names corresponding, respectively, to the plural column name abbreviations included in the prompt. In various examples, the one of the AI models 230a-n provides the output to the expansion server 225 as an API response (e.g., if the prompt was sent to the one of the AI models 230a-n in an API call) or a web service response (e.g., if the prompt was sent to the one of the AI models 230a-n in a web service call). In embodiments, the output processing module 240 parses the output received from the one of the AI models 230a-n to extract the expanded table name and the expanded column names from the output.

In some embodiments, the output processing module 240 is configured to process the output by generating a glossary of terms that equates the table name abbreviation to the expanded table name and that equates respective ones of the plural column name abbreviations to respective ones of the plural expanded column names. In one example, the output processing module 240 automatically generates the glossary of terms (e.g., without being based on additional input from the user) and stores the glossary of terms in the database 215 or in a knowledge catalog associated with the database 215.

In some embodiments, the output processing module 240 is configured to process the output by modifying the table in the database 215 by adding labels to the plural columns in the table, wherein each respective one of the labels includes a respective one of the plural expanded column names corresponding to a respective one of the plural column name abbreviations. In one example, the output processing module 240 automatically modifies the table with this information, e.g., by modifying the database schema metadata for the table in the database 215. In this manner, each column of the table includes its column name abbreviation and also is associated with an expanded column name that corresponds to the column name abbreviation, the expanded column name having been extracted from the output of the one of the AI models 230a-n.

In some embodiments, the output processing module 240 is configured to process the output by modifying the database 215 by storing metadata links between respective ones of the plural column name abbreviations and respective ones of the plural expanded column names. The links may be added to and stored as part of the database schema metadata for the table in the database 215.

In some embodiments, the output processing module 240 is configured to process the output by analyzing the output by comparing the output to one or more ground truths and generating a report that includes a result of the analyzing. In embodiments, the one or more ground truths comprise expected results, e.g., an expected expanded column name for a respective column name abbreviation. The one or more ground truths may be provided by a subject matter expert. The analyzing may involve generating a confidence score of the output based on comparing the output to one or more ground truths. The report may include the confidence score.

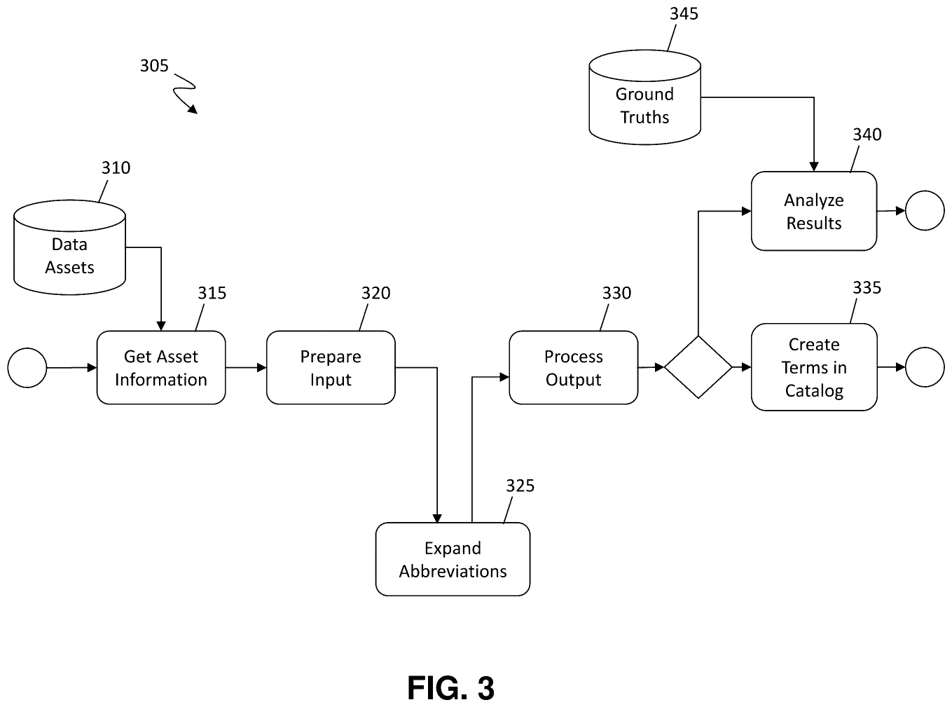

FIG. 3 shows a block diagram that illustrates an exemplary workflow 305 in accordance with aspects of the present invention. Block 310 represents data assets comprising one or more tables that have abbreviated table names and abbreviated column names and may correspond to the database 215 of FIG. 2. Block 315 represents getting information from the data assets of block 310 and corresponds to the prompt generation module 235 of FIG. 2 obtaining a table name abbreviation and column name abbreviations of a table in a database. Block 320 represents preparing an input for an AI model and corresponds to the prompt generation module 235 of FIG. 2 generating a prompt that includes the table name abbreviation and column name abbreviations. Block 325 represents expanding the abbreviations and corresponds to the one of the AI models 230a-n of FIG. 2 receiving the prompt that includes the table name abbreviation and column name abbreviations and generating an output based on the prompt. Block 330 represents processing the output and corresponds to the output processing module 240 of FIG. 2 extracting the expanded table name and the expanded column names from the output of the one of the AI models 230a-n by parsing the output. Block 335 represents creating terms in a catalog (e.g., a knowledge catalog) and corresponds to the output processing module 240 of FIG. 2 generating a glossary of terms that equates the table name abbreviation (e.g., from the prompt) to the expanded table name (e.g., from the output), and that equates respective ones of the plural column name abbreviations (e.g., from the prompt) to respective ones of the plural expanded column names (e.g., from the output). Block 340 represents analyzing the results based on one or more ground truths 345 and corresponds to the output processing module 240 of FIG. 2 analyzing the output by comparing the output to one or more ground truths and generating a report that includes a result of the analyzing.

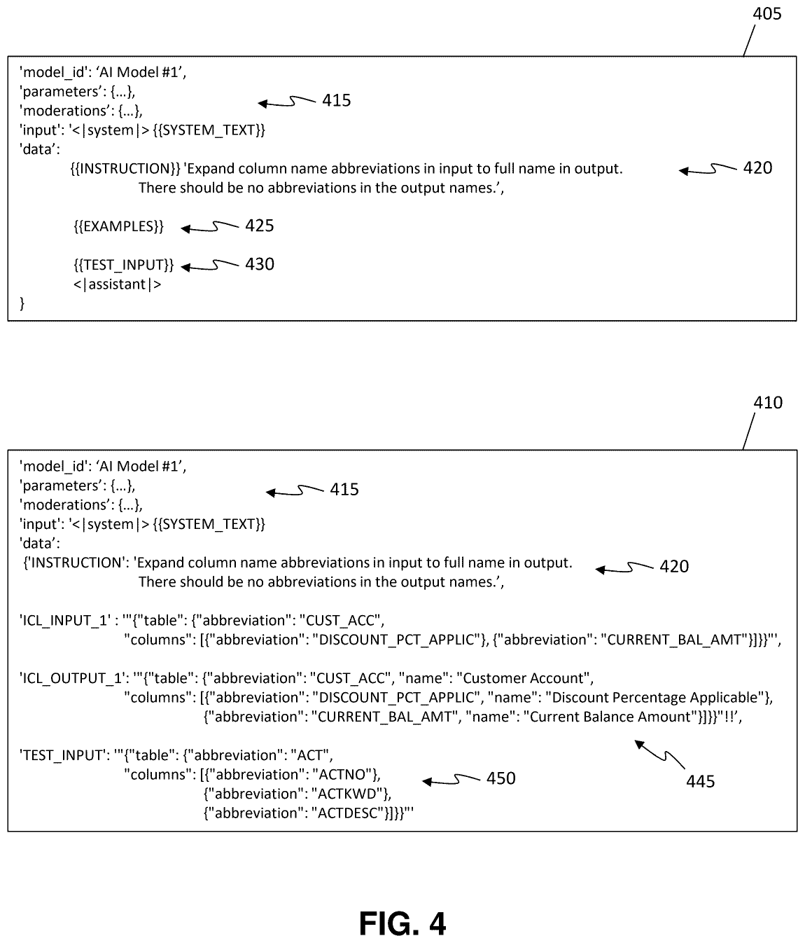

FIG. 4 shows an exemplary predefined prompt format 405 and an exemplary generated prompt 410 in accordance with aspects of the present invention. In the example shown in FIG. 4, the prompt format 405 includes model information 415 (e.g., “model id”, parameters, moderations, and system text), an instruction 420 (e.g., to the AI model), a placeholder 425 for examples, and a placeholder 430 for input data. In this example, the predefined prompt format 405 corresponds to (e.g., is tailored to) a first one of the AI models 230a-n of FIG. 2 having a “model id” of “AI Model #1.” In this example, the prompt 410 represents a prompt generated by the prompt generation module 235 of FIG. 2 by adding abbreviations 450 (e.g., the table name abbreviation and plural column name abbreviations obtained from the database 215 of FIG. 2) to the predefined prompt format 405 at the placeholder 430 for input data. Although only three column abbreviations are shown in the abbreviations 450 in this example, it is to be understood that the abbreviations may include hundreds or thousands of column name abbreviations associated with a table in a database. In this manner, the prompt generation module 235 of FIG. 2 is configured to provide a single prompt including up to hundreds or thousands of column name abbreviations to the one of the AI models 230a-n of FIG. 2 in a single call to the one of the AI models 230a-n, subject to the prompt-size limits for the AI model.

With continued reference to the example shown in FIG. 4, generating the prompt 410 may include the prompt generation module 235 of FIG. 2 adding examples 445 (e.g., one or more abbreviations and expansions corresponding to the abbreviations) to the predefined prompt format 405 at the placeholder 425 for examples. The examples 445 may be provided by the prompt generation module 235 or may be obtained from user input via the client device 220 of FIG. 2. It is noted that examples are optional, and a predefined prompt format and a generated prompt need not include examples.

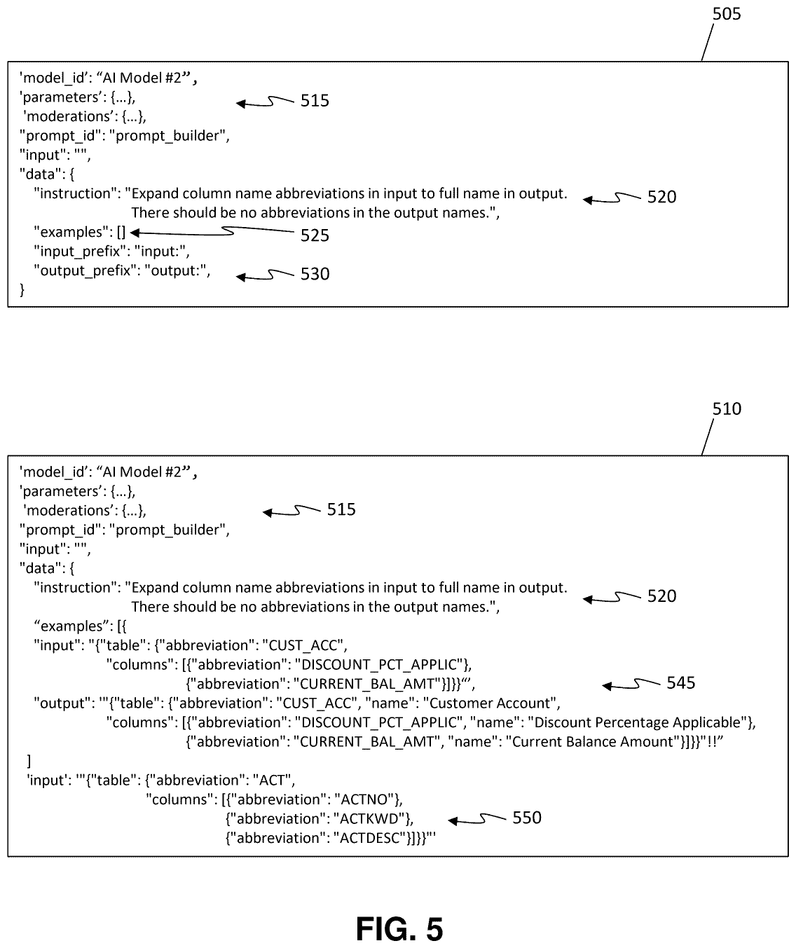

FIG. 5 shows another exemplary predefined prompt format 505 and an exemplary generated prompt 510 in accordance with aspects of the present invention. In the example shown in FIG. 5, the prompt format 505 includes model information 515 (e.g., “model id”, parameters, moderations, “prompt id” and system text), an instruction 520 (e.g., to the AI model), a placeholder 525 for one or more examples, and placeholder 530 for input data. In this example, the predefined prompt format 505 corresponds to (e.g., is tailored to) a second one of the AI models 230a-n of FIG. 2 having a “model id” of “AI Model #2.” In this example, the prompt 510 represents a prompt generated by the prompt generation module 235 of FIG. 2 by adding abbreviations 550 (e.g., the table name abbreviation and plural column name abbreviations obtained from the database 215 of FIG. 2) to the predefined prompt format 505 at the placeholder 530 for input data. Although only three column abbreviations are shown in the abbreviations 550 in this example, it is to be understood that the abbreviations may include hundreds or thousands of column name abbreviations associated with a table in a database. In this manner, the prompt generation module 235 of FIG. 2 is configured to provide a single prompt including up to hundreds or thousands of column name abbreviations to the one of the AI models 230a-n of FIG. 2 in a single call to the one of the AI models 230a-n, subject to the prompt-size limits for the AI model.

With continued reference to the example shown in FIG. 5, generating the prompt 510 may include the prompt generation module 235 of FIG. 2 adding examples 545 (e.g., one or more abbreviations and expansions corresponding to the abbreviations) to the predefined prompt format 505 at the placeholder 525 for examples. The examples 545 may be provided by the prompt generation module 235 or may be obtained from user input via the client device 220 of FIG. 2. It is noted that examples are optional, and a predefined prompt format and a generated prompt need not include examples.

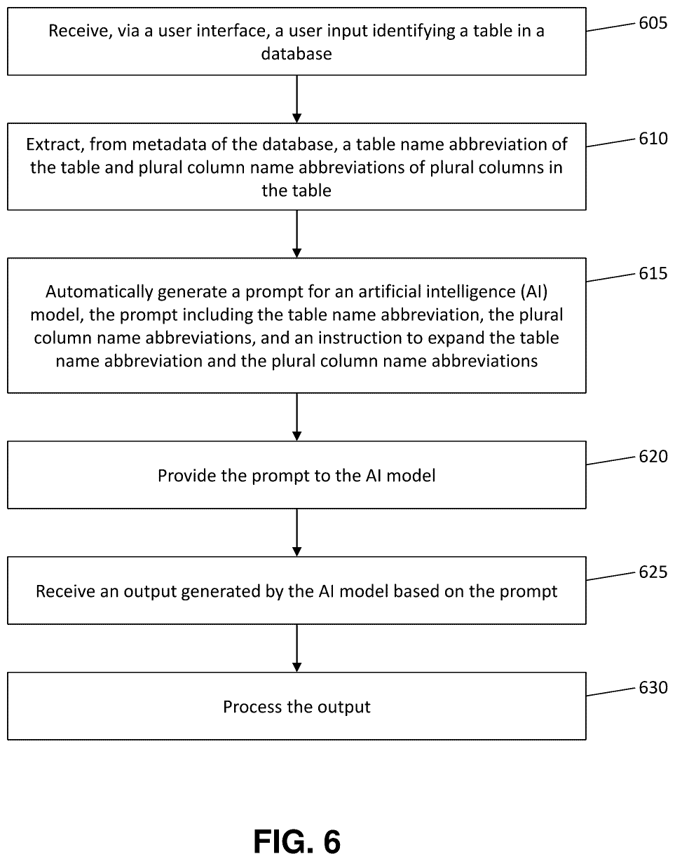

FIG. 6 shows a flowchart of an exemplary method in accordance with aspects of the present invention. Steps of the method may be carried out in the environment of FIG. 2 and are described with reference to elements depicted in FIG. 2.

At step 605, the system receives, via a user interface, a user input identifying a table in a database. In embodiments, and as described with respect to FIG. 2, the expansion server 225 receives the user input via a user interface of the client device 220.

At step 610, the system extracts, from metadata of the database, a table name abbreviation of the table and plural column name abbreviations of plural columns in the table. In embodiments, and as described with respect to FIG. 2, the prompt generation module 235 extracts abbreviations of a table from the database 215.

At step 615, the system automatically generates a prompt for an artificial intelligence (AI) model, the prompt including the table name abbreviation, the plural column name abbreviations, and an instruction to expand the table name abbreviation and the plural column name abbreviations. In embodiments, and as described with respect to FIG. 2, the prompt generation module 235 generates the prompt.

At step 620, the system provides the prompt to the AI model. In embodiments, and as described with respect to FIG. 2, the prompt generation module 235 sends the prompt generated at step 615 to the one of the AI models 230a-n.

At step 625, the system receives an output generated by the AI model based on the prompt. In embodiments, and as described with respect to FIG. 2, the output processing module 240 receives the output from the one of the AI models 230a-n.

At step 630, the system processes the output. In embodiments, and as described with respect to FIG. 2, the output processing module 240 processes the output received at step 625.

In embodiments of the method, the output at step 625 includes: an expanded table name corresponding to the table name abbreviation; and plural expanded column names corresponding, respectively, to the plural column name abbreviations.

In embodiments of the method, the processing the output comprises automatically generating and storing a glossary of terms that: equates the table name abbreviation to the expanded table name; and equates respective ones of the plural column name abbreviations to respective ones of the plural expanded column names.

In embodiments of the method, the processing the output comprises automatically modifying the table in the database by adding labels to the plural columns in the table, wherein each respective one of the plural labels includes a respective one of the plural expanded column names corresponding to a respective one of the plural column name abbreviations.

In embodiments of the method, the processing the output comprises automatically modifying the database by storing metadata links between respective ones of the plural column name abbreviations and respective ones of the plural expanded column names.

In embodiments of the method, the processing the output comprises: analyzing the output by comparing the output to one or more ground truths; and generating a report that includes a result of the analyzing.

In embodiments of the method, the automatically generating the prompt comprises: obtaining a predefined prompt format for the AI model; and arranging the table name abbreviation and the plural column name abbreviations in a JavaScript Object Notation format in the predefined prompt format.

In embodiments of the method, the method further comprises receiving user input selecting the AI model from plural AI models that are available to the user, wherein the generating the prompt for the AI model comprises generating the prompt using one of plural predefined prompt formats that is specific to the AI model.

In embodiments of the method, the plural columns constitute all the columns in the table, such that the AI model expands all the plural column name abbreviations of the table in a single call.

In embodiments of the method, the prompt includes one or more examples each comprising an abbreviation and an expansion of the abbreviation.

In embodiments of the method, the AI model comprises a trained generative AI model.

In embodiments of the method, the AI model comprises a trained large language model.

In embodiments, a service provider could offer to perform the processes described herein. In this case, the service provider can create, maintain, deploy, support, etc., the computer infrastructure that performs the process steps in accordance with aspects of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, implementations provide a computer-implemented method, via a network. In this case, a computer infrastructure, such as computer 101 of FIG. 1, can be provided and one or more systems for performing the processes in accordance with aspects of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes in accordance with aspects of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method, comprising:
receiving, by a processor set and via a user interface, a user input identifying a table in a database;
extracting, by the processor set and from metadata of the database, a table name abbreviation of the table and plural column name abbreviations of plural columns in the table;
automatically generating, by the processor set, a prompt for an artificial intelligence (AI) model, the prompt including the table name abbreviation, the plural column name abbreviations, and an instruction to expand the table name abbreviation and the plural column name abbreviations;
providing, by the processor set, the prompt to the AI model;
receiving, by the processor set, an output generated by the AI model based on the prompt; and
processing, by the processor set, the output.

2. The computer-implemented method of claim 1, wherein the output includes:
an expanded table name corresponding to the table name abbreviation; and
plural expanded column names corresponding, respectively, to the plural column name abbreviations.

3. The computer-implemented method of claim 2, wherein the processing the output comprises automatically generating and storing a glossary of terms that:
equates the table name abbreviation to the expanded table name; and
equates respective ones of the plural column name abbreviations to respective ones of the plural expanded column names.

4. The computer-implemented method of claim 2, wherein the processing the output comprises automatically modifying the table in the database by adding labels to the plural columns in the table, wherein each respective one of the labels includes a respective one of the plural expanded column names corresponding to a respective one of the plural column name abbreviations.

5. The computer-implemented method of claim 2, wherein the processing the output comprises automatically modifying the database by storing metadata links between respective ones of the plural column name abbreviations and respective ones of the plural expanded column names.

6. The computer-implemented method of claim 2, wherein the processing the output comprises:
analyzing the output by comparing the output to one or more ground truths; and
generating a report that includes a result of the analyzing.

7. The computer-implemented method of claim 1, wherein the automatically generating the prompt comprises:
obtaining a predefined prompt format for the AI model; and
arranging the table name abbreviation and the plural column name abbreviations in a JavaScript Object Notation format in the predefined prompt format.

8. The computer-implemented method of claim 1, further comprising receiving user input selecting the AI model from plural AI models that are available to the user, wherein the generating the prompt for the AI model comprises generating the prompt using one of plural predefined prompt formats that is specific to the AI model selected.

9. The computer-implemented method of claim 1, wherein the plural columns constitute all the columns in the table, such that the AI model expands all the plural column name abbreviations of the table in a single call.

10. The computer-implemented method of claim 1, wherein the prompt includes one or more examples each comprising an abbreviation and an expansion of the abbreviation.

11. The computer-implemented method of claim 1, wherein the AI model comprises a trained generative AI model.

12. The computer-implemented method of claim 1, wherein the AI model comprises a trained large language model.

13. A computer program product comprising one or more computer readable storage media having program instructions collectively stored on the one or more computer readable storage media, the program instructions executable to:
extract, from metadata of a table in a database, a table name abbreviation of the table and plural column name abbreviations of plural columns in the table;
automatically generate a prompt for an artificial intelligence (AI) model, the prompt including the table name abbreviation, the plural column name abbreviations, and an instruction to expand the table name abbreviation and the plural column name abbreviations;
provide the prompt to the AI model using a single call to the AI model;
receive an output generated by the AI model based on the prompt; and
process the output.

14. The computer program product of claim 13, wherein the output includes:
an expanded table name corresponding to the table name abbreviation; and
plural expanded column names corresponding, respectively, to the plural column name abbreviations.

15. The computer program product of claim 13, wherein the automatically generating the prompt comprises:
obtaining a predefined prompt format for the AI model; and
arranging the table name abbreviation and the plural column name abbreviations in a JavaScript Object Notation format in the predefined prompt format.

16. The computer program product of claim 13, wherein the prompt includes one or more examples each comprising an abbreviation and an expansion of the abbreviation.

17. A system comprising:
a processor set, one or more computer readable storage media, and program instructions collectively stored on the one or more computer readable storage media, the program instructions executable to:
extract, from metadata of a table in a database, a table name abbreviation of the table and plural column name abbreviations of plural columns in the table;
automatically generate a prompt for an artificial intelligence (AI) model, the prompt including the table name abbreviation, the plural column name abbreviations, and an instruction to expand the table name abbreviation and the plural column name abbreviations;
provide the prompt to the AI model using a call to the AI model, wherein the call comprises a single application programming interface (API) call to the AI model or a single web service call to the AI model;
receive an output generated by the AI model based on the prompt; and
process the output.

18. The system of claim 17, wherein the output includes:
an expanded table name corresponding to the table name abbreviation; and
plural expanded column names corresponding, respectively, to the plural column name abbreviations.

19. The system of claim 17, wherein the automatically generating the prompt comprises:
obtaining a predefined prompt format for the AI model; and
arranging the table name abbreviation and the plural column name abbreviations in a JavaScript Object Notation format in the predefined prompt format.

20. The system of claim 17, wherein the prompt includes one or more examples each comprising an abbreviation and an expansion of the abbreviation.
